(19) United States
(12) Patent Application Publication
(10) Pub. No.: US 2022/0009266 A1
(43) Pub. Date: Jan. 13, 2022

(54) Childrens Character Journal

(71) Applicants: Charles Lovern, IV, Buford, GA (US); Heather Lovern, buford, GA (US)

(72) Inventors: Charles Lovern, IV, Buford, GA (US); Heather Lovern, buford, GA (US)

(21) Appl. No.: 16/926,746

(22) Filed: Jul. 12, 2020

(51) Int. Cl. B42D 3/08; B42D 1/00; B44F 7/00; B42D 3/06

(52) U.S. Cl. CPC B42D 3/08; B42D 3/06; B44F 7/00; B42D 1/00

(57) ABSTRACT

A journal for writing comprising a front cover and rear cover attached via a hinge. The front cover and rear cover enveloped by a plush fabric creating a soft unibody of an animal or character. Anatomical features carried by the front cover. The anatomical features including a face having facial features resembling the facial features of a particular animal or character. The anatomical features including certain features which are raised in a three dimensional manner above the soft unibody providing for a stuffed animal or character presentation. A plurality of writing surfaces carried within the front cover and said rear cover providing for a journal for writing.

### FIELD OF THE INVENTION

The present invention relates generally to a journal for writing thoughts and more particular to a journal for writing thoughts which has a cover which represents an animal or character which provides a a friendly welcoming environment enticing a child to utilize the journal to collect their thoughts.

### BACKGROUND OF THE INVENTION

Writing in journals is shown to improve the mental health of individuals. Overall, journaling/expressive writing has been found to:

Boost your mood/affect;

Enhance your sense of well-being;

Reduce symptoms of depression before an important event (like an exam);

Reduce intrusion and avoidance symptoms post-trauma

Improve your working memory

Writing enhances our mental health by guiding towards confronting previously inhibited emotions (reducing the stress from inhibition), helping process difficult events and compose a coherent narrative about our experiences, and possibly even through repeated exposure to the negative emotions associated with traumatic memories journal. It has shown effectiveness in helping people identify and accept their emotions, manage stress and ease the symptoms of mental illness.

It has even been shown to impact physical well-being as studies suggesting journaling can strengthen the immune system, drop blood pressure, help you sleep better, and generally keep you healthier.

With the mental benefits that journaling produces, there is a need to invite and entice children to put their mental thoughts in a journaling process and because sometimes difficult issues may be discussed, the writing environment should be warm and friendly.

Accordingly, it is an object of the present invention to provide for a writing journal directed to children which provides a warm and enticing environment.

### SUMMARY OF THE INVENTION

A journal for writing which includes a front cover and rear cover attached via a hinge. The front cover and rear cover are enveloped by a plush fabric creating a soft unibody of an animal or character. Anatomical features are carried by the front cover. The anatomical features include a face having facial features resembling the facial features of a particular animal or character. The anatomical features including certain features which are raised in a three dimensional manner above the soft unibody providing for a stuffed animal or character presentation. A plurality of writing surfaces carried within the front cover and said rear cover providing for a journal for writing.

### DESCRIPTION OF THE DRAWING FIGURES

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 illustrates a child utilizing a friendly journal for writing down their thoughts according to an embodiment of the invention;

FIG. 2 illustrates an animated front cover of a friendly journal for providing for an enthusiastic and friendly environment for enticing children journaling their thoughts according to an embodiment of the invention;

FIG. 3 illustrates the journal being opened exposing the writing surface while still maintaining an animated character according to an embodiment of the invention.

### DETAILED DESCRIPTION

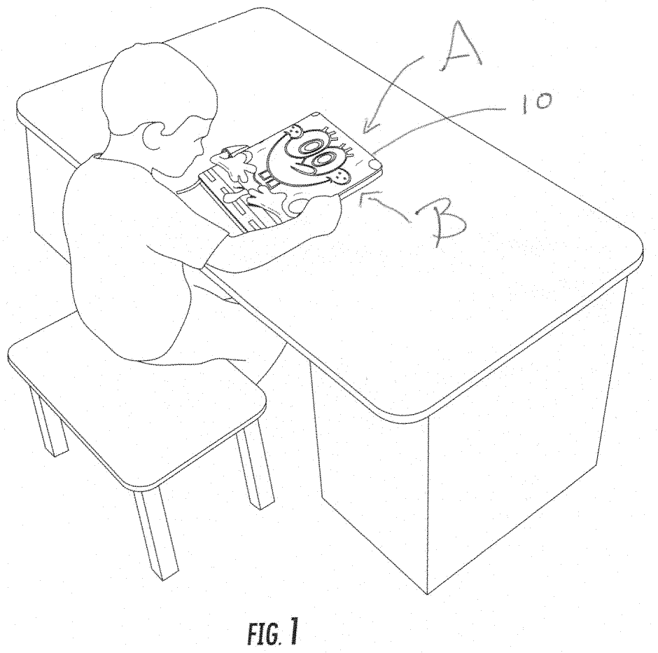

As shown in FIG. 1, a writing journal A provides a child the opportunity to write their thoughts in a manner to facilitate their mental health. Writing journal A provides a friendly experience mimicking a one to one conversation with an animated character B which constitutes the front cover 10 of the writing journal.

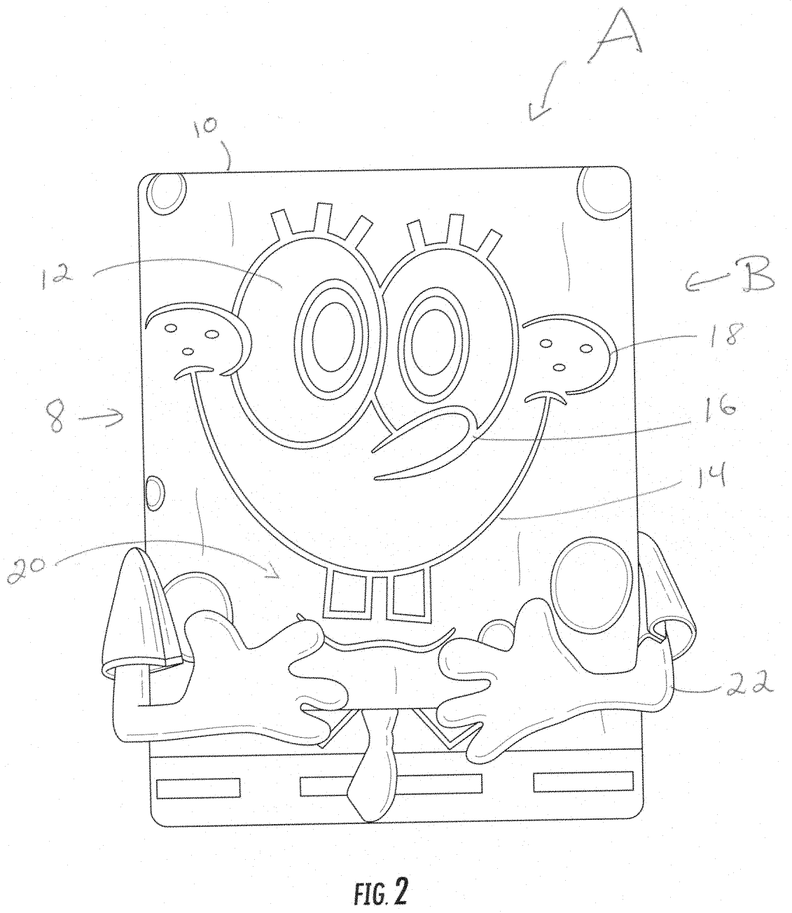

As shown in FIG. 2, writing journal A includes front cover 10 which features an animated character B. Animated character B may be a cartoon character or an animal. The animated character B is constructed to provide friendly friend or pet situation. Each character includes a face 8 having facial features including eyes 12, a mouth 14, nose 16, ears 18 and a principle body 20. Additional features which would be associated with a character such as arms, a tie, a tail, a inane, fins, stripes, etc. depending on the natural appearance of the associated animal By providing a face utilizing eyes, a mouth, a nose, ears and a principle body, the character provides a friendly and warm facial expression presenting an animated animal. An important feature of the invention is that body 20 consists of a plush soft material providing a surface area pleasant to the touch. With the soft body, face 8 provides a realistic animal appearance. In the preferred embodiment body 20 consists of an irregular 3-d surface. In certain embodiments, face 8 may include a filler material for raising face 8 in an extended manner above body 20. Additional features like ears 18 may consist of an additional fabric from the plush body or face 8 to provide an additional 3-d surface. In additional embodiments nose 16 may be elevated. Additional 3d features such as arms 22 may be provided. Each of these 3d-features extend beyond the profile of plush body 20.

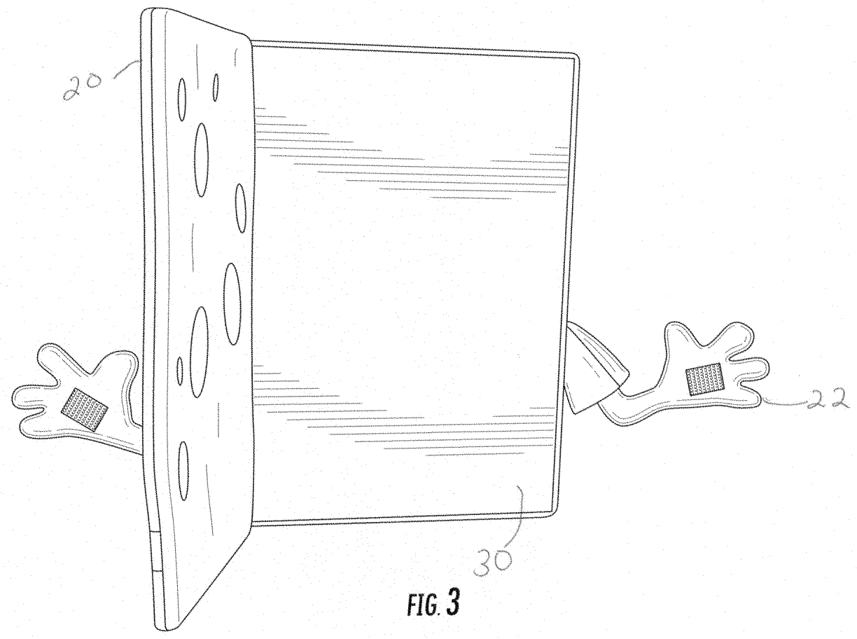

As shown in FIG. 3, a writing surface 30 is provided. Writing surface 30 preferably includes a plurality of journal pages where the individual may journal their thoughts. In certain embodiments, anatomical features of the body 20 may extend beyond the side profiles of the journal A. In this manner, the visual association of the journal being a pet is maintained maintaining the pleasant journal experiment.

Accordingly, an improved journal experience may be maintained by an individual by providing a journal which presents a friendly environment. By providing a journal which resembles an animated character such as an animal, a 1-1 writing experience may be maintained. For instance if the journal resembles a well known character or a friendly baby lion, the individual, such as a child, may create a bonding experience with the character. To facilitate in this bonding experience, the character is presented in a 3-d manner with life like qualities which would render the journal in a manner to be received as pet such as stuffed animal journal. By providing a friendly face, the individual such as a child may bond with the pet portion of the journal enticing the child to utilize the journal thereby helping improve the mental health of the child.

What is claimed is:

1. A journal for writing comprising:
a front cover and rear cover attached via a hinge;
said front cover and rear cover enveloped by a plush fabric creating a soft unibody of an animal or character;
anatomical features carried by the front cover, said anatomical features including a face having facial features resembling the facial features of a particular animal or character;
said anatomical features including certain features which are raised in a three dimensional manner above said soft unibody providing for a stuffed animal or character+presentation; and
a plurality of writing surfaces carried within said front cover and said rear cover providing for a journal for writing.

2. The journal of claim 1 wherein said face is elevated above said body presenting a three dimensional appearance with respect to said body providing an illusion of an animated character.

3. The journal of claim 1 wherein ears are elevated above said body presenting a three dimensional appearance with respect to said body providing an illusion of an animated character.

4. The journal of claim 1 wherein appendages extend beyond the profile of the front and back covers.

5. The journal of claim 1 wherein said facial features include eyes, ears, a nose and mouth resembling the facial features of a particular animal or character.

6. The journal of claim 1 wherein said animated character is an animal.

7. A journal for writing comprising:
a front cover and rear cover attached via a hinge;
said front cover and rear cover enveloped by a plush fabric creating a soft unibody of an animal or character;
anatomical features carried by the front cover, said anatomical features including a face having facial features resembling the facial features of an animal;
said face being elevated above said body presenting a three dimensional appearance with respect to said body providing an illusion of an animated character having a soft unibody providing for a stuffed animal; and
a plurality of writing surfaces carried within said front cover and said rear cover providing for a journal for writing.

8. The journal of claim 1 wherein ears are elevated above said body presenting a three dimensional appearance with respect to said body providing an illusion of an animated character.
